(19) United States
(12) Patent Application Publication
(10) Pub. No.: US 2025/0309411 A1
(43) Pub. Date: Oct. 2, 2025

(54) POWER SUPPLY SYSTEM, METHOD FOR CONSTRUCTING A POWER SUPPLY SYSTEM AND USE OF THE POWER SUPPLY SYSTEM

(71) Applicant: WILO SE, Dortmund (DE)

(72) Inventor: Richard SCHMIDT, Dortmund (DE)

(73) Assignee: WILO SE, Dortmund (DE)

(21) Appl. No.: 18/866,326

(22) PCT Filed: May 25, 2023
(86) PCT No.: PCT/EP2023/064081

§ 371 Date: Nov. 15, 2024

(30) Foreign Application Priority Data
May 27, 2022 (EP) 22175915.2
Sep. 29, 2022 (DE) 20 2022 105 518.1

(51) Int. Cl. H01M 16/00; H01M 8/04029; H01M 8/04082; H01M 8/04828; H01M 8/0612; H01M 8/0656

(52) U.S. Cl. CPC H01M 16/006; H01M 8/04029; H01M 8/04201; H01M 8/04835; H01M 8/0618; H01M 8/0656; H01M 2250/10; H01M 2250/20; H01M 2250/405

(57) ABSTRACT

The invention relates to a power supply system comprising a modular combination of a hydrogen generation unit, a hydrogen usage unit and a control or regulation unit for controlling or regulating the operation of the hydrogen generation unit and the hydrogen usage unit.

The invention relates to a power supply system, a method for constructing a modular power supply system, a method for operating the same and a use of the power supply system and its elements.

In recent decades, the share of renewable energies in the global energy balance has risen steadily. A central technical problem in connection with the increasing use of renewable energies lies in the synchronization of generation and demand and thus in the efficiency of storage, transport and distribution. A well-known way to store generated energy is to convert it into hydrogen. This is becoming increasingly important where the primary energy sources are subject to temporal fluctuations, such as solar and wind energy. At the same time, however, alternatives to natural gas and other fuels are also becoming increasingly important, so that hydrogen is also becoming more significant here.

The object of the present patent application is to optimize the use of secondary energy sources and, in particular, to provide a more efficient power supply system with respect to the prior art, a method for the construction and operation of this power supply system, and uses of the power supply system and its elements. The power supply system, the methods and the uses are particularly advantageous in connection with the use of renewable energies as a primary source.

The object is achieved with a power supply system comprising a modular combination of a hydrogen generation unit, a hydrogen usage unit and a control or regulation unit for controlling or regulating the operation of the hydrogen generation unit and the hydrogen usage unit.

The basic idea of the invention is to create a modular and universally applicable power supply system for secondary energy storage and/or usage, which in particular allows adaptations to the demand of certain sectors, industries or other specific needs, while being designed for an integrated construction and being controlled or regulated accordingly.

The combination in the sense of the invention means that the combined units are connected to each other, e.g. via material transfer lines for the supply or removal of fluids or solids, wired or wireless data connections for the exchange of information and/or energy transfer lines for the transfer of electrical and/or thermal energy.

The system is modular. The units or sub-units or other added components of the system are here intended to be modules.

Insofar as the singular is used in the application in connection with the hydrogen generation unit or the hydrogen usage unit, this is to be understood as a designation of the genus, unless another understanding is mandatory. Thus, when the system refers to “one unit”, it may also have two or more hydrogen generation units or two or more hydrogen usage units.

The hydrogen generation unit preferably has an electrolysis device that uses electricity, preferably from a renewable energy source, to split water into hydrogen and oxygen. The electrolysis device can work according to different principles, e.g. using ion exchange membranes, for example anion exchange membranes (AEM), or proton exchange membranes (PEM).

The electrolysis device has at least one electrolyzer, but preferably a large number, e.g. at least 10, preferably at least 50, more preferably at least 100 or at least 200 individual electrolyzers, each of which is functionally capable of electrolysis. For example, the AEM Multicore® electrolyzer system from Enapter® can be used. It is also possible to use different electrolyzers that work on different principles in parallel.

An alternative or additional component of the hydrogen generation unit can be a plasmalysis device, which uses electricity, preferably from a renewable energy source, to generate a plasma that generates hydrogen from water, in particular wastewater or water containing various waste products. Additional product substances that may be generated in the process, such as methane, CO2 or N2, can be used for other purposes.

The system according to the invention can also be designed in such a way that the hydrogen generation unit can be operated independently of a power source. For this purpose, a pyrolysis device can be provided as an alternative variant of the hydrogen generation unit. Solid carbon can be obtained as a further product in the process. The required process heat is preferably generated from renewable energies.

Another alternative or additional component of the hydrogen generation unit can be a reforming device, with which hydrogen is generated using heat from a fossil energy source, in particular methane, and with the addition of water. CO2 can be obtained as a further product, which can be used for other purposes. The required process heat is preferably generated from renewable energies.

The hydrogen generation unit can be operated with a single type of the aforementioned devices, i.e. either with at least one electrolysis device or at least one plasmalysis device or at least one pyrolysis device or at least one reforming device. In the hydrogen generation unit, however, different types of the aforementioned devices can also be used in combination, so that a hydrogen generation unit, for example, comprises both at least one electrolysis unit and at least one plasmalysis device. In this way, the system can use various raw materials as a source of hydrogen, e.g. purified water for the electrolysis device(s), waste water for the plasmalysis device(s), methane for the pyrolysis device(s) and methane and water for the reforming device(s). The control or regulation unit can be used to control or regulate the distribution of different raw materials to the appropriate hydrogen generation units, for example depending on the available quantities of raw materials, the availability of the respective hydrogen generation units and/or the demand from hydrogen usage units.

The hydrogen generation unit can be designed as a locally contiguous unit. However, it is also possible that the hydrogen generation unit is composed of at least two hydrogen generation subunits that are spatially separated from one another, wherein each of the hydrogen generation subunits alone can have a certain type of the aforementioned devices or a combination thereof.

The power supply system according to the invention can comprise a raw material storage, e.g. in the form of one or more tanks, for each raw material, such as, for example, water, wastewater or methane. In the system according to the invention, the raw material storage is connected or can be connected to the hydrogen generation unit for the supply of the raw material. The supply and discharge can be controlled or regulated in an automated manner by the control or regulation unit, e.g. via controllable or regulable valves.

The power supply system according to the invention can be designed in such a way that a hydrogen storage is provided as the hydrogen usage unit. Preferably, the hydrogen storage is a gas storage, preferably a low-pressure storage with a maximum pressure of the stored hydrogen of preferably 60 bar, more preferably 50 bar. Storage in a high-pressure gas storage is also conceivable. The hydrogen can also be liquefied and then stored in liquid form.

However, the hydrogen storage tank can also be a solid storage tank, e.g. a metal hydride storage tank, an adsorptive storage tank and/or a chemical storage tank that uses a chemical bond between the hydrogen and a carrier substance. Such a carrier can be, for example, magnesium or a magnesium compound, magnesia (magnesium carbonate, magnesium oxide or manganese dioxide), CO2 for the formation of formic acid or a liquid organic carrier (LOHC).

The hydrogen storage can be limited to one of the aforementioned variants. However, the hydrogen storage variants described above and also those not listed here can be used in combination with each other, so that a hydrogen usage unit, for example, comprises at least two different hydrogen storage variants. By means of the control or regulation unit, the hydrogen generated by the hydrogen generation unit can be supplied to different hydrogen storage units as required.

The hydrogen storage unit or at least one of the hydrogen storage units can be part of a dispensing device for hydrogen, e.g. as a component of a refueling station where, for example, vehicles can be refueled. The dispensing device can also be part of an industrial plant or a residential or office complex or another property or can be connected to other consumer units, e.g. a combined heat and power plant.

According to the invention, the power supply system can have an H2 delivery interface as a hydrogen usage unit, e.g. a connection for a pipeline or for a hydrogen distribution point.

The hydrogen usage unit can also be an energy generation device for generating thermal and/or electrical energy. Preferably, the energy generation device comprises at least one fuel cell. The fuel cell has a connection for receiving the electrical energy generated. Possible recipients for the electrical energy can be, for example, electrical consumers or one or more batteries, but also the power supply system or parts thereof.

A plurality of fuel cells are preferably used, which are preferably supplied with hydrogen in parallel and can be connected electrically in parallel or in series. The control or regulation unit can be used to control or regulate the amount of hydrogen supplied to the fuel cell per unit of time. Furthermore, if a large number of fuel cells are used, the control or regulation unit can also be used to control the type of electrical connection of the fuel cells, i.e. whether a certain number of fuel cells are connected in parallel or in series, e.g. depending on the electrical voltage or current required.

Preferably, the heat generated during the operation of the fuel cell(s) is utilized, e.g. by dissipating and utilizing or storing the heat via suitable solid or fluid heat conductors, preferably also via one or more heat exchangers.

The power supply system according to the invention can also be designed in such a way that the hydrogen usage unit is a combined heat and power plant. In the combined heat and power plant, the hydrogen is used to drive an electricity generator, e.g. as the fuel of an internal combustion engine, wherein the heat generated is simultaneously used, e.g. for heating purposes or for hot water preparation.

The hydrogen usage unit can also be a power machine that performs mechanical work by converting one form of energy of the hydrogen, e.g. thermal, pneumatic or chemical energy, e.g. as a combustion engine, into kinetic energy. Excess heat can also be utilized here, e.g. dissipated and utilized or stored.

According to the invention, the power supply system can also be designed in such a way that several hydrogen usage units can be provided in parallel or in series in the combination. For example, a hydrogen storage tank for supplying hydrogen can be connected to the hydrogen generation unit and itself serve as a supplier for an energy generation device, i.e. by being interposed.

Furthermore, further functional units can be part of the power supply system, e.g. a dryer unit for drying the hydrogen generated before it is used, e.g. stored or chemically utilized.

If the hydrogen generation unit is also operated with electrical energy, in particular from renewable energies, it may be advantageous to connect a buffer storage, preferably a chargeable battery, to the hydrogen generation unit. In this way, power fluctuations on the part of the energy source, e.g. a photovoltaic system or a wind power plant, can be compensated. The buffer storage is preferably set up to communicate with the control or regulation unit. The buffer storage or the battery can be supplied by the hydrogen usage unit if required.

The power supply system according to the invention can also be designed in such a way that at least one unit is provided for uninterruptible power supply (UPS unit). A temporary power failure can thus be overcome. If the power outage lasts longer than a defined period of time, the UPS unit can be used to ensure that the system is shut down in a controlled manner by the control or regulation unit. A UPS unit can also be provided at an interface between the system according to the invention and a consumer of a power supply offered by the system, for example a property. In this case, the UPS unit protects the consumer.

Components of the power supply system that generate heat during operation, for example the hydrogen generation unit(s), e.g. electrolysis unit(s), or the hydrogen usage unit(s), such as the fuel cell(s), can serve as heat source(s) for other components of the system, e.g. for an adsorption chiller. The latter can be used, for example, for air conditioning in building complexes. The heat can also be stored in heat storages, e.g. liquid storages or solid storages, for later use. A heat storage can also be integrated as a module in the power supply system. Preferably, the system as a whole or in parts is operated adiabatically.

The power supply system according to the invention can also be supplied with energy from outside, for example electricity or heat. However, it can be advantageous if the power supply system according to the invention has its own secondary energy source as a modular component, which supplies the generated secondary energy directly or indirectly to the hydrogen generation unit. Preferably, the secondary energy source is a power generator, for example a photovoltaic system, a wind turbine or a hydroelectric power plant. This means that the power supply system according to the invention can be designed for self-sufficient operation, i.e. independently of the supply of secondary energy generated outside the power supply system.

The control or regulation unit can be set up in such a way that the system is shut down in a controlled manner when predetermined conditions are met, e.g. when the public grid fails and a shutdown is required, e.g. in accordance with VDE 4105-AR 2018. For the controlled shutdown, the control and regulation unit can be set up in such a way that an emergency supply of the consumers is guaranteed for at least a specified period of time and that priorities in the energy management for components of the system are provided as needed.

Furthermore, the control or regulation unit can be set up in such a way that changes to the power supply system, in particular expansions or reductions, can be carried out, wherein the control or regulation unit can also be used to control or regulate a module integrated or put into operation in the system for expansion purposes and, in the event of a downsizing due to the removal or deactivation of a module, the control or regulation for the remaining modules remains undisturbed or is adapted as required. Expansions can be provided, for example, by additional hydrogen generation units, such as electrolysis devices, or additional hydrogen usage units, such as hydrogen storage or fuel cells. In this way, the entire power supply system is scalable. The use of a plurality of small hydrogen storage units is particularly preferred, which can be advantageous for scalability and filling speed. The individual hydrogen storage unit can have a capacity of less than 6T, preferably less than 3T.

All modules or a partial number of modules of the power supply system can be spatially combined, preferably in a module unit, more preferably with an enclosure. The module unit can be designed to be transportable. The module unit and/or the modules preferably have standard dimensions, for example dimensions of freight containers, so that a delivery or a change of location of a preferably prefabricated power supply system in the module unit is possible. Standardization of the modules and/or the module unit facilitates an adaptation, in particular an expansion of the power supply system, to local conditions or changes in the requirements on the power supply system.

With regard to the method, the technical problem is solved by the features of claim 23. The control or regulation unit controls or regulates the hydrogen generation unit and the hydrogen usage unit in a coordinated manner using predefined parameters. Preferably, the control and regulation unit also takes into account parameters of further units or boundary conditions, e.g. data of the secondary energy source, the degree of availability of raw materials for hydrogen generation and/or the demand of consumers connected to the power supply system.

The control or regulation unit is preferably designed to be open for an expansion of the system by means of further modules. The system can thus be constructed in modules and, if necessary, expanded or reduced in capacity and/or in applications and uses. An expansion can be achieved, for example, by adding a new module or (re) commissioning or activating a module that is already connected, e.g. an additional secondary source and/or an additional hydrogen generation unit, such as a fuel cell and/or a plasmalyser and/or an additional hydrogen usage unit, such as a hydrogen storage tank, a fuel cell and/or a combined heat and power unit, or a dryer unit, an UPS unit, an adsorption chiller or any other additional modules. Conversely, a downsizing means the removal of a module from the power supply system or the deactivation of a module physically remaining in the power supply system.

It may be envisaged that when the power supply system is expanded by adding or activating a module, this module will be integrated into the coordinated control or regulation system and/or that when a module is removed or deactivated, the coordinated control or regulation of the remaining active modules will be automatically adjusted. For example, if a hydrogen storage unit has to be removed from the power supply system, for example for maintenance or repair, the activity of the hydrogen generation unit(s) can be automatically reduced and/or the consumption at another hydrogen usage unit increased in response to the reduced total storage capacity.

The object is also achieved by a method according to claim 25, whereby the following steps are provided for setting up a modular power supply system:
a) determination of a possible primary energy source as well as an energy requirement and/or a power requirement,
b) selection of a suitable secondary energy source for the determined primary energy source and for the energy or power requirement,
c) assembly and packaging of a hydrogen generation unit and a hydrogen usage unit, and
d) provision and installation of a control or regulation unit for the coordinated control or regulation of the hydrogen generation unit and the hydrogen usage unit.

In this way, for example, a power supply system according to the invention, as shown above, can be designed, taking full account of requirements and parameters.

As primary energy sources, renewable resources are preferably used, such as solar, wind, water and tides, geothermal energy or biomass.

Secondary energy sources are understood to be devices and measures that convert the energy that can be extracted from primary energy sources into technically usable forms of energy, in particular electricity or heat, preferably photovoltaic systems, wind turbines, hydroelectric and tidal power plants, geothermal plants or plants for utilizing biomass.

The method according to the invention for setting up a modular power supply system can also be carried out in such a way that further modules are integrated into the power supply system, whereby integration into the control or regulation of the control or regulation unit is included. Examples of modules are a further hydrogen generation unit, a further hydrogen usage unit, a dryer unit for the hydrogen generated, and/or a raw material storage unit for a raw material for hydrogen generation, for example wastewater, rainwater and/or drinking water.

One use of the power supply system according to the invention is to form a local power supply or to support a local power supply. The power supply can be the supply of, for example, electrical energy, thermal energy and/or hydrogen as a fuel. Preferably, it is a self-sufficient power supply, i.e. one that is independent of the input of external suppliers.

The use according to the invention can be advantageous the formation of an emergency power system or an emergency power generator, whereby the security of supply in the event of a temporary outage by an external energy supplier can be ensured.

The use of the system according to the invention for peak shaving is particularly preferred. With peak shaving, a consumer quickly and temporarily reduces its power consumption in order not to cause an unwanted peak load. In order to be able to realize such load shedding without a reduction in consumption associated with undesirable restrictions, the system according to the invention can be connected to the external power supply, e.g. by using a hydrogen usage unit and/or a battery module present in the system.

The use according to the invention preferably concerns the power supply of a property. It can also be advantageous to integrate the system according to the invention into the building management. Furthermore, the use according to the invention can advantageously relate to the power supply of a charging point for battery-powered units, e.g. vehicles.

Preferably, the use according to the invention can also provide that at least a portion of the electricity generated by the system is fed into the public grid. This can result in a reimbursement and contribute to the stability of the public grid.

Another use of the system for storing and using secondary energy in accordance with the invention is the use of waste water. Waste water can be used as a raw material for the hydrogen generation unit, e.g. after treatment for electrolysis or without or with less treatment for plasmalysis.

In the following, exemplary embodiments of the power supply system according to the invention, of the method for constructing a power supply system and of the operation of a power supply system and uses thereof are illustrated by means of figures.

In particular

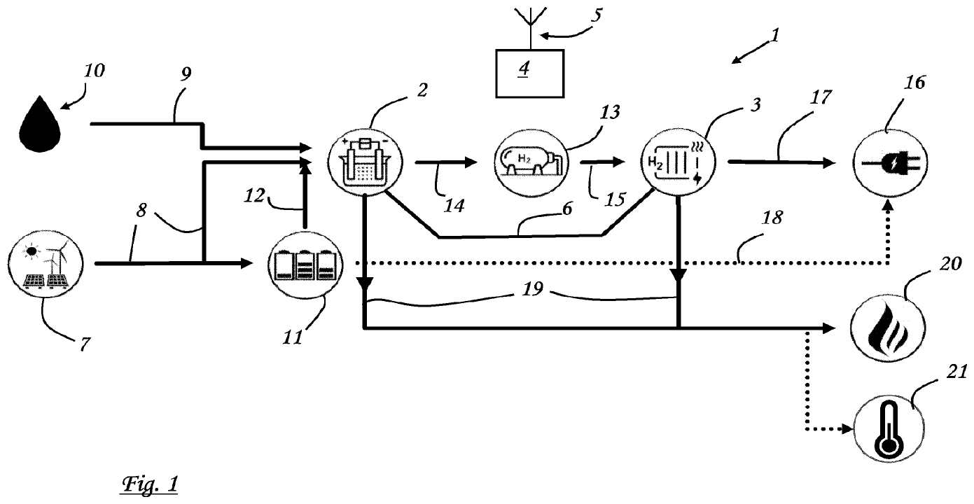

FIG. 1: shows a first modular power supply system 1 and

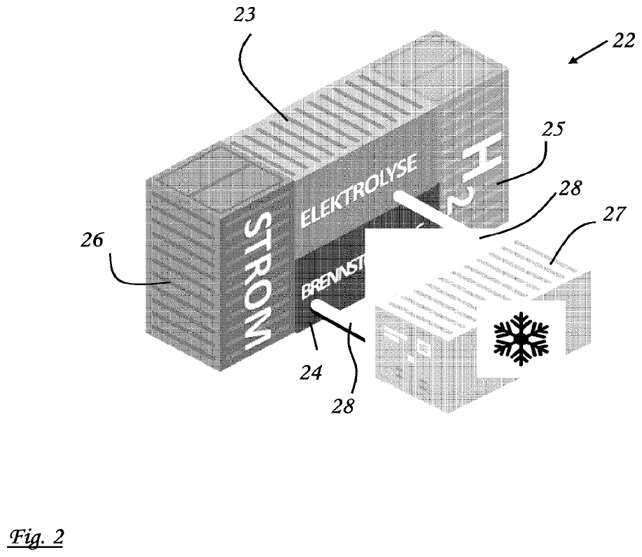

FIG. 2: shows a compact module unit made of modules of a second power supply system with a further module of a chiller connected thereto.

FIG. 1 schematically shows a first modular power supply system 1 with a hydrogen generation unit 2 as a first module, a first hydrogen usage unit 3 as a second module and a control or regulation unit 4 as a third module, which is connected wirelessly (symbolized by an antenna symbol 5) to the hydrogen generation unit 2 and the hydrogen usage unit 3. Alternatively, a wired connection is also possible.

For the hydrogen generation unit 2, electrolysis is preferably used as the process. Alternative methods, such as plasmalysis or pyrolysis, or combinations of different processes are also conceivable. Different methods can be used in the same power supply system. In the case of electrolysis, a large number of electrolyzers not shown here can be used to achieve a high throughput, which also allow flexible reaction to demand fluctuations and to reduce or increase the number of electrolyzers currently in use by means of the control or regulation unit 4.

For the hydrogen usage unit 3, which can be supplied with hydrogen from hydrogen generation unit 4 via a hydrogen line 6, fuel cell technology is preferably used to generate electrical power, preferably in a large number of individual fuel cells not shown here. The number of fuel cells required during operation can vary and can be determined by the control or regulation unit 4, for example depending on the amount of hydrogen available or the demand of one or more consumers.

The hydrogen generation unit 2 is supplied with the energy necessary for hydrogen generation, for example with electric current, via a first power supply line 8 from a secondary energy source 7, which is preferably a photovoltaic system, a wind power plant and/or another system that uses renewable primary energy. The secondary energy source 7 can be a module of the power supply system 1 or can be arranged externally, e.g. in the public grid. Alternatively or additionally, the power supply system 1 can also be fed from secondary energy sources that use non-regenerative primary energies.

The raw material necessary for hydrogen generation, e.g. water, drinking water, rainwater or wastewater, is fed, if necessary after treatment, via a raw material supply line 9 from a raw material source 10, designed, for example, as a storage tank, to the hydrogen generation unit 2. Preferably, the source of raw material 10 is also a module of the power supply system 1.

Preferably, a buffer storage 11 can be provided as a further optional module for the energy supplied by the secondary energy source 7, so that fluctuations in the supply of energy to the hydrogen generation unit 2 or in the demand of the hydrogen generation unit 2 can be compensated. The buffer storage 11 is connected to the hydrogen generation unit 2 by a second power supply line 12. If the energy to be supplied is electric current, the buffer storage 11 can be a battery storage. The buffer storage 11 can also be connected to the fuel cell and powered by it.

A hydrogen storage tank 13 is preferably used as the second hydrogen usage unit, which is supplied with hydrogen by the hydrogen generation unit 2 via an H2 storage input line 14. The hydrogen storage tank 13 supplies the first hydrogen usage unit 3 with hydrogen as required via an H2 storage output line 15. The supply of the first hydrogen usage unit 3 via the hydrogen storage 13 and/or directly from the hydrogen generation unit 2 is controlled or regulated via the control or regulation unit 4 preferably depending on the demand of the first hydrogen usage unit 3 and on the load of the hydrogen generation unit 2.

The power supply system 1 can be used to supply a single consumer or multiple consumers of different types. Symbolically, FIG. 1 shows an electrical consumer 16 which is supplied with electrical power via a first power line 17 from the first hydrogen usage unit 3. If necessary, the electrical consumer 16 can alternatively or additionally be supplied directly from the buffer storage 11 via a second power line 18.

Preferably, heat generated during operation at the hydrogen generation unit 2 and/or at the first hydrogen usage unit 3 is supplied to a heat consumer 20 via heat lines 19, preferably via a fluid heat transfer medium. Preferably, the waste heat can be supplied to a chiller 21, for example an adsorption chiller, as an alternative or in addition to the supply.

Further modules not shown in the figures can be used, such as a dryer unit for drying the hydrogen generated before storage or before any other use, in particular in a fuel cell. Instead of or in addition to fuel cells, a combined heat and power plant can be used.

To construct the power supply unit 1, the availability of a primary energy source, such as solar, wind, hydroelectric, geothermal and/or biomass, is first checked and the demand of energy to be generated by the power supply system is determined. For this purpose, a suitable secondary energy source or, optionally, at least two secondary energy sources, also of different types in the same power supply system, are determined. The modules are selected and assembled to match these preferences, and the control and regulation unit is set up appropriately so that the modules are controlled or regulated in a coordinated manner during operation.

It is advantageous if the modules can be pre-assembled and packaged by the manufacturer and preferably also already fixed in place in relation to one another in module housings. Ideally, the power supply unit can be delivered prefabricated as a complete unit or assembled at the delivery site like a modular system. A device for explosion protection can be provided.

FIG. 2 schematically shows a module unit 22, which comprises central modules of a second exemplary power supply system, wherein functional units of the modules themselves are not visible, but rather only several module housings assembled to form the module unit, in which the functional units are arranged. An electrolysis unit, which is not visible here, is housed in a first module housing 23 and a power generation unit, which is also not visible, having fuel cells, is housed in a second module housing 24.

A third module housing 25 preferably has means for transferring the hydrogen generated by the electrolysis unit to the fuel cells situated in the second module housing 24. A hydrogen storage tank, which is not visible here, is preferably arranged in the third module housing 25.

A fourth module housing 26 preferably relates to the power supply for the electrolysis unit and preferably has a buffer storage, e.g. in the form of a battery storage, which is not visible here. The fourth module housing can also have other equipment, e.g. means for a power connection for the electrolysis unit, without a buffer storage.

It is also advantageous to have a control or regulation unit, not shown in FIG. 2, in the module unit 22, e.g. in the fourth module housing 26. Each of the module housings 23 to 26 can have several modules of the second power supply system.

Connections for the supply of energy, in particular electric current, and/or raw materials, in particular water, can be provided or attached in the module unit, preferably in a standardized manner in terms of design and arrangement.

FIG. 2 shows a fifth module housing 27, which encloses a chiller, preferably an adsorption chiller, which is not visible here. For its operation, the chiller is supplied via heat lines 28 with the waste heat from both the fuel cells located in the second module housing 24 and the electrolysis unit located in the first module housing 23.

The module unit can also be realized by a single housing enclosing all or a partial number of the modules.

The module unit and/or the module housings preferably have standard dimensions, for example dimensions of freight containers. In addition to facilitating transport, this also facilitates the assembly of the entire power supply system and its expansion with additional modules or module units.

### LIST OF REFERENCE NUMERALS

1 energy supply system
2 hydrogen generation unit
3 first hydrogen usage unit
4 control or regulation unit
5 antenna
6 hydrogen line
7 secondary energy source
8 first power supply line
9 raw material supply line
10 raw material source
11 buffer storage
12 second power supply line
13 hydrogen storage
14 H2 storage input line
15 H2 storage output line
16 electrical consumer
17 first power line
18 second power line
19 heat line
20 heat consumer
21 chiller
22 module unit
23 first module housing
24 second module housing
25 third module housing
26 fourth module housing
27 fifth module housing
28 heat line

1. A power supply system, comprising a modular combination of
a) a hydrogen generation unit,
b) a hydrogen usage unit and
c) a control or regulation unit for controlling or regulating the operation of the hydrogen generation unit and the hydrogen usage unit.

2. The power supply system according to claim 1, characterized in that
the hydrogen generation unit has an electrolysis device.

3. The power supply system according to claim 2, characterized in that
the electrolysis device comprises at least one electrolyzer, preferably at least 10, more preferably at least 50, still more preferably at least 100 electrolyzers.

4. The power supply system according to any one of the preceding claims, characterized in that the hydrogen generation unit has at least one plasmalysis device, at least one pyrolysis device and/or at least one reforming device.

5. The power supply system according to any one of the preceding claims, characterized by at least one raw material storage, preferably in the form of one or more tanks, for a raw material, in particular water, waste water or methane, to be supplied to the hydrogen generation unit.

6. The power supply system according to any one of the preceding claims, characterized in that a hydrogen storage tank is provided as the hydrogen usage unit.

7. The power supply system according to claim 6, characterized in that the hydrogen usage unit has as hydrogen storage means at least one gas storage, preferably at least one low-pressure storage, at least one liquid gas storage, at least one solid storage, preferably a metal hydride storage, at least one adsorptive storage and/or at least one chemical storage.

8. The power supply system according to any one of the preceding claims, characterized in that an H₂ delivery interface, in particular a connection for a pipeline or for a distribution point for hydrogen, is provided as the hydrogen usage unit.

9. The power supply system according to any one of the preceding claims, characterized in that an energy generation device for generating thermal and/or electrical energy is provided as the hydrogen usage unit.

10. The power supply system according to claim 9, characterized in that the energy generation device comprises at least one fuel cell and/or at least one combined heat and power plant.

11. The power supply system according to claim 10, characterized in that the energy generation device comprises at least two fuel cells, the fuel cells preferably being connected in parallel to a hydrogen supply.

12. The power supply system according to claim 11, characterized in that the fuel cells can be connected electrically in parallel or in series by means of the control or regulation unit.

13. The power supply system according to any one of the preceding claims, characterized in that the hydrogen usage unit comprises a power machine that performs mechanical work.

14. The power supply system according to any one of the preceding claims, characterized in that, in combination, a plurality of hydrogen usage units are connected in parallel and/or in series to the hydrogen generation unit.

15. The power supply system according to any one of the preceding claims, characterized by a dryer unit for drying the hydrogen generated.

16. The power supply system according to any one of the preceding claims, characterized by an electrical buffer storage, preferably a chargeable battery, preferably supplied by the fuel cell, connected upstream of the hydrogen-generating unit.

17. The power supply system according to any one of the preceding claims, characterized in that at least one unit is provided for uninterruptible power supply to the power supply system.

18. The power supply system according to any one of the preceding claims, characterized in that modules of the power supply system which generate heat during operation, in particular the hydrogen generation unit and/or the hydrogen usage unit, serve as heat sources for further components.

19. The power supply system according to any one of the preceding claims, characterized by a refrigeration unit, in particular an adsorption chiller.>

20. The power supply system according to any one of the preceding claims, characterized by a secondary energy source, wherein the power supply system is set up to supply the secondary energy generated by the secondary energy source directly or indirectly to the hydrogen generation unit.

21. The power supply system according to any one of the preceding claims, characterized in that the control or regulation unit is set up to shut down the power supply system in a controlled manner when predefined conditions are fulfilled.

22. The power supply system according to any one of the preceding claims, characterized in that the control or regulation unit is or can be set up to
include a module added to the operation of the power supply system in the coordinated control or regulation and/or
when a module is removed from the operation of the power supply system, automatically adjust the regulation or control of the remaining active modules.

23. The power supply system according to any one of the preceding claims, characterized by a water treatment system.

24. A method for operating a power supply system according to any one of claims 1 to 23, in which the control or regulation unit controls or regulates the hydrogen generation unit and the hydrogen usage unit in a coordinated manner using predetermined parameters.

25. A method according to claim 24, characterized in that
a module is incorporated into the operation of the power supply system, this module is integrated into the coordinated control or regulation and/or
when a module is removed from operation, the coordinated control or regulation of the remaining active modules is automatically adapted.

26. A method for constructing a modular power supply system, comprising the following steps:
a) determining a possible primary energy source as well as an energy requirement and/or a power requirement,
b) selecting a secondary energy source suitable for the determined primary energy source and for the energy or power requirement,
c) assembling and packaging a hydrogen generation unit and a hydrogen usage unit, and
d) providing and setting up a control or regulation unit for the coordinated control or regulation of the hydrogen generation unit and of the hydrogen usage unit.

27. The method according to claim 26, characterized by integrating further modules, in particular
a dryer unit for the hydrogen generated,
a raw material storage for a raw material for hydrogen generation,
an electrical buffer storage connected upstream of the hydrogen generation unit,
a unit for an uninterruptible power supply, and/or
a refrigeration unit, in particular an adsorption chiller, in the power supply system, including integration into the control or regulation of the control or regulation unit.

28. Use of the power supply system according to any one of claims 1 to 23 for the formation of a local power supply or for the support of a local power supply.

29. Use according to claim 28 for the formation of a self-sufficient power supply.

30. Use according to claim 28 for the formation of an emergency power supply system or an emergency power generator unit.

31. Use according to any one of claims 28 to 30 for peak shaving.

32. Use according to any one of claims 28 to 31, characterized in that the power supply of a property is designed or supported.

33. Use according to any one of claims 28 to 32, characterized in that the power supply of a charging point for battery-powered units, e.g. vehicles, is designed or supported.

34. Use according to any one of claims 28 to 33, characterized in that at least a portion of the electricity generated is fed into the public electricity grid and/or at least a portion of the hydrogen generated is fed into a public hydrogen supply.

35. Use of the power supply system according to any one of claims 1 to 23 for wastewater usage.
